(19) United States
(12) Patent Application Publication
(10) Pub. No.: US 2026/0041274 A1
(43) Pub. Date: Feb. 12, 2026

(54) WATER DISPENSING APPARATUS, SYSTEMS AND METHODS FOR DISPENSING WATER AND BREWED BEVERAGES

(71) Applicant: Natural Choice Corporation, Loves Park, IL (US)

(72) Inventors: George Knoll, Belvidere, IL (US); Matthew Mickelson, Rockford, IL (US); Kerry Roosmalen, Northfield, MN (US)

(21) Appl. No.: 18/800,802

(22) Filed: Aug. 12, 2024

(51) Int. Cl. A47J 31/40; A23L 2/54; A47J 31/04; A47J 31/44; A47J 31/46; A47J 31/52

(52) U.S. Cl. CPC A47J 31/407; A47J 31/04; A47J 31/461; A47J 31/52; A23L 2/54; A47J 31/4428; A47J 2203/00

(57) ABSTRACT

Water dispensing apparatus, systems, and methods of using the same provide a tank or chamber for heating and dispensing hot water and further comprises a system for routing hot water to a hot water dispenser outlet in a first hot water path and a hot beverages dispenser outlet in a second hot water path. Systems and methods for dispensing hot water and brewed beverages is further provided.

### TECHNICAL FIELD

The present invention relates to water dispensing apparatus, systems, and methods of using the same. Specifically, the water dispensing apparatus comprises a tank for heating and dispensing hot water and further comprises a system for routing hot water to a hot water dispenser outlet in a first path and a brewed beverage dispenser outlet in a second path. Systems and methods for dispensing hot water and brewed beverages is further provided.

### BACKGROUND

Units are known to provide sparkling water, and for heating and cooling water and dispensing the same for users thereof. It is often desirable for a user to select whether he or she wishes to receive water having different properties, such as heated, cooled, or carbonated. Typical machines for accomplishing such tasks generally include a tank for holding water and/or a tap water supply line for inputting water therein for dispensing. Oftentimes, machines utilize a tank for chilling the water and a tank for heating the water in the same machine. Moreover, machines that are known to provide carbonation to water to create sparkling water further comprise a carbonation unit comprising a holding tank for dissolving carbon dioxide in water for immediate dispensing when desired.

Water dispensing apparatuses typically do not dispense water, such as hot water, cold water, room temperature (ambient) water and/or carbonated water, as well as a brewed beverage, such as coffee, tea, or other like beverages. While it is possible to obtain only hot water through an apparatus that can brew beverages, oftentimes, this water is simply routed through the brewed beverage receptacle without brewed beverage components or ingredients, such as a “brewing pod,” therein. For example, a Keurig® machine utilizes plastic pods of ground coffee or other like material. For making a brewed beverage, a user adds a pod of coffee to a receptacle and closes the same, adding water to the machine or having the machine draw water from a pre-filled tank. After the user selects the brewed beverage option, hot water is drawn into a hot water tank, and heated until it is dispensed from the hot water tank through a tube into the receptacle containing the pod, where the hot water flows through the pod. The pod acts as a filter and the hot water brews the coffee therein, whereupon the coffee is disposed therebeneath into a cup or container. To dispense just hot water, typically the same process is utilized except no pod is added to the receptacle, and the hot water is merely routed through the receptacle into a waiting cup or container.

By routing water through the receptacle that typically contains the brewed beverage pods, the water dispensed is typically not pure and often includes dissolved brewed beverage that are retained by the receptacle after a prior use. Even if cleaned, residual brewed beverage may still linger in hot water. In addition, coffee grounds and or tea material often escape from the pods when disposed within the receptacle, and these grounds and teas can then be flushed via the hot water into a user's cup or container.

A need, therefore, exists for an improved water dispensing apparatus. Specifically, a need exists for an improved water dispensing apparatus that dispenses water, such as, for example, hot water, cold water, room temperature water, and/or sparkling water and that also dispenses a brewed beverage. More specifically, a need exists for an improved water dispensing apparatus that dispenses pure hot water and does not mix the dispensing of the hot water and the brewed beverage within the same dispenser.

In addition, it is often difficult to precisely meter hot water through a brewed beverage apparatus. Most pod brew systems simply use dispense time as a surrogate for water volume; however, flow rate can vary over time causing uneven and inaccurate dispense volumes.

In addition, users often desire to have specific sizes of brewed beverages and particular strengths thereof. For example, for a brewed beverage such as coffee, where caffeine intake and/or coffee flavor strength is often regulated by coffee drinkers, users are often particular about getting small, medium, large, or other sizes depending on their needs and desires. Oftentimes, however, brewed beverage apparatuses do not dispense the proper amount of hot water for brewing.

A need, therefore, exists for an improved water dispensing apparatus that precisely meters hot water when brewing. Specifically, a need exists for an improved water dispensing apparatus that provides a desired amount of brewed beverage when dispensing the same. More specifically, a need exists for an improved water dispensing apparatus that provides an accurate and consistent volume of hot water through its brewed beverages component for brewing the desired brewed beverage.

Thermal expansion within a hot water tank, such as in typical hot water dispensing systems, often leads to the use of an expansion chamber or overflow tank that is positioned atop a hot water tank. Typically, the expansion chamber is permanently affixed to the hot water tank by welding or other means. As water heats inside the hot water tank, it rises into the expansion chamber instead of through the dispensing faucet through one or more holes that are positioned along the outlet tubing from the hot water tank to the faucet. The holes are typically arranged in size and location to aid in pulling the water out of the expansion chamber and into the dispensing stream to the faucet due to the Venturi effect. In this manner, the expansion chamber fills and empties in an ongoing cycle.

However, water that is captured within the expansion chamber is typically never fully emptied and can become stagnant if the tanks do not easily or readily drain. This stagnant water is typically of low quality for purposes of drinking or cooking.

A need, therefore, exists for water dispensing apparatuses comprising hot water expansion chambers that effectively capture hot water that overflows from a hot water tank and provides effective draining therefrom when drawn or when the overflow condition ends. More specifically, a need exists for water dispensing apparatuses that provide full draining from an overflow tank so that hot water within the overflow tank does not become stale or stagnant.

Moreover, expansion chambers are typically vented so that hot water can fill and drain easily without increasing pressure within the expansion chamber and/or creating a vacuum when drained, both conditions would prevent proper functioning of the expansion chamber. However, when hot water is drawn from the expansion chamber through the Venturi holes, air from the vents may be drawn with the hot water stream causing turbulent flow that splashes from the faucet. A need, therefore, exists for an expansion chamber whereby only hot water is withdrawn and not air. More specifically, a need exists for an expansion chamber whereby the hot water stream is continuous and smooth without turbulence caused by unwanted air.

In addition, because of the proximity of the expansion chamber to boiling water, mineral scale buildup continually occurs inside the expansion chamber. When the Venturi holes become clogged, the water system itself must typically be disposed of as service is often difficult or hazardous due to the nature of the hot water and electrical systems. A need, therefore, exists for an expansion chamber that is easily replaced in the event of scale buildup or failure. More specifically, a need exists for a modular and separable expansion chamber, and a bracket for easily removing and replacing the expansion chamber when necessary.

Moreover, in a dispenser of sparkling water, as well as other waters, such as, for example, hot water, cold water, and/or ambient water, a dispenser faucet, such as shown in U.S. Pat. No. 10,399,839, water is typically fed into the faucet through separate ports via respective solenoid valves connected to each port that extends from the back surface of the faucet main body. Sparkling water is governed by a restrictor setting, the tightening of which restricts sparkling water flow therethrough. However, since sparkling water is pressurized by a CO2 supply, sparkling water can back up from the nozzle at the bottom of the faucet to the top of the faucet. One or more vent holes are generally provided at the top of the faucet to allow complete drainage of water through the faucet by preventing pressure differences within the faucet. If the sparkling water backs up to the one or more vent holes, sparkling water can spill from the vent holes and spray or splash from the top of the faucet.

A need, therefore, exists for an improved water dispensing faucet for sparkling water. Specifically, a need exists for an improved dispensing faucet that prevents spraying or splashing of sparkling water therefrom during dispensing. More specifically, a need exists for an improved dispensing faucet that effectively blocks one or more vents in the dispensing faucet during sparkling water backup to prevent spraying or splashing of the same.

### SUMMARY OF THE INVENTION

The present invention relates to water dispensing apparatus, systems, and methods of using the same. Specifically, the water dispensing apparatus comprises a tank for heating water and separate chamber for dispensing the hot water and further comprises a system for routing the hot water to a hot water dispenser outlet via a first hot water path and a hot beverage dispenser outlet via a second hot water path. Systems and methods for dispensing hot water and brewed beverages is further provided.

To this end, in an embodiment of the present invention, a water dispensing apparatus is provided. The water dispensing apparatus comprises: a hot water tank; and a dispense chamber disposed above the hot water tank comprising an inlet for moving hot water from the hot water tank to the dispense chamber, a first outlet for moving hot water via a first path from the dispense chamber to a hot water dispenser outlet, and a second outlet for moving hot water via a second path from the dispense chamber to a beverage ingredient chamber containing an amount of a beverage ingredient for forming a hot beverage when combined with the hot water, wherein the hot water flows alternately through the first water path to the first dispenser and through the second water path to the second dispenser.

In an embodiment, the beverage ingredient chamber is a brew chamber configured to hold the beverage ingredient.

In an embodiment, the brew chamber is configured to dispense a brewed beverage therefrom when hot water flows through the second water path and the beverage ingredient is held within the brew chamber.

In an embodiment, the water dispensing apparatus further comprises: a clamp configured to close the first water path when the hot water is configured to flow through the second water path.

In an embodiment, the water dispensing apparatus further comprises: a valve associated with the dispense chamber wherein the valve is configured to close one or more vents in the hot water tank when the hot water is configured to flow through the second water path.

In an embodiment, the water dispensing apparatus further comprises: a pump associated with the dispense chamber wherein the pump is configured to move water within the dispense chamber through the second water path.

In an embodiment, the pump is configured to move a predefined amount of water through the second water path.

In an embodiment, the hot water within the dispense chamber is measured using one or more sensor probes.

In an embodiment, the water dispensing apparatus further comprises: at least one sensor probe for measuring the amount of hot water within the dispense chamber.

In an embodiment, the hot water tank and the dispense chamber comprise a water flow pathway that is configured to allow water to flow from the hot water tank to the dispense chamber.

In an alternate embodiment of the present invention, a method of dispensing hot water from a dispensing apparatus is provided. The method comprises the steps of: providing a hot water tank for forming hot water; providing a dispense chamber disposed above the hot water tank comprising a hot water inlet for moving the hot water from the hot water tank to the dispense chamber, a first outlet for moving the hot water in a first water path from the dispense chamber to a hot water dispenser outlet, and a second outlet for moving the hot water in a second water path from the dispense chamber to a beverage ingredient chamber containing an amount of a beverage ingredient for forming a hot beverage when combined with the hot water and further wherein the second path comprises a hot beverage dispenser outlet for dispensing the hot beverage after combining the hot water with the beverage ingredient; and moving the hot water alternately through the first water path or through the second water path.

In an embodiment, the beverage ingredient chamber is configured to hold a brew-able material, and further comprises the steps of: filling the beverage ingredient chamber with the brew-able material; moving the hot water through the second water path to the beverage ingredient chamber and brewing the brew-able material within the beverage ingredient chamber to form a brewed beverage; and dispensing the brewed beverage through the hot beverage dispenser outlet.

In an embodiment, the method further comprises the step of: dispensing the brewed beverage from the brewed beverage dispenser.

In an embodiment, the method further comprising the steps of: providing a clamp configured to close the first water path; and clamping the first water path closed when moving the hot water through the second water path.

In an embodiment, the method further comprises the steps of: providing a valve associated with the dispense chamber configured to close one or more vents in the hot water tank; and closing the one or more vents in the hot water tank via the valve.

In an embodiment, the method further comprises the steps of: providing a pump associated with the dispense chamber wherein the pump is configured to move water within the dispense chamber through the second water path; and moving the hot water from the dispense chamber through the second water path.

In an embodiment, the method further comprising the steps of: measuring a first amount of hot water within the dispense chamber; and moving the first amount of hot water through the second water path with the pump.

In an embodiment, the amount of water within the dispense chamber is measured using one or more sensor probes.

In an embodiment, the method further comprises the steps of: filling the dispense chamber with a second amount of hot water; and moving the second amount of hot water through the second water path with the pump.

In an embodiment, the hot water tank and the dispense chamber comprise a water flow pathway that is configured to allow water to flow from the hot water tank to the dispense chamber.

It is, therefore, an advantage and objective of the present invention to provide improved water dispensing apparatuses.

Specifically, it is an advantage and objective of the present invention to provide improved water dispensing apparatuses that dispense water, such as, for example, hot water, cold water, room temperature water, and/or sparkling water and that also dispenses a brewed beverage.

More specifically, it is an advantage and objective of the present invention to provide improved water dispensing apparatuses that dispense pure hot water and does not mix the dispensing of the hot water and the brewed beverage within the same dispenser.

In addition, it is an advantage and objective of the present invention to provide improved water dispensing apparatuses that precisely meters hot water when brewing.

Specifically, it is an advantage and objective of the present invention to provide improved water dispensing apparatuses that provide a desired amount of brewed beverage when dispensing the same.

More specifically, it is an advantage and objective of the present invention to provide improved water dispensing apparatuses that provide an accurate and consistent volume of hot water through its brewed beverages component for brewing the desired brewed beverage.

Moreover, it is an advantage and objective of the present invention to provide improved water dispensing apparatuses comprising hot water expansion chambers that effectively capture hot water that overflows from a hot water tank and provides effective draining therefrom when drawn or when the overflow condition ends.

More specifically, it is an advantage and objective of the present invention to provide improved water dispensing apparatuses that provide full draining from an overflow tank so that hot water within the overflow tank does not become stale or stagnant.

Further, it is an advantage and objective of the present invention to provide an expansion chamber whereby only hot water is withdrawn and not air.

More specifically, it is an advantage and objective of the present invention to provide an expansion chamber whereby the hot water stream is continuous and smooth without turbulence caused by unwanted air.

Still further, it is an advantage and objective of the present invention to provide an expansion chamber that is easily replaced in the event of scale buildup or failure.

More specifically, it is an advantage and objective of the present invention to provide a modular and separable expansion chamber, and a bracket for easily removing and replacing the expansion chamber when necessary.

In addition, it is an advantage and objective of the present invention to provide an improved water dispensing faucet for sparkling water.

Specifically, it is an advantage and objective of the present invention to provide an improved dispensing faucet that prevents spraying or splashing of sparkling water therefrom during dispensing.

More specifically, it is an advantage and objective of the present invention to provide an improved dispensing faucet that effectively blocks one or more vents in the dispensing faucet during sparkling water backup to prevent spraying or splashing of the same.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a water dispenser apparatus in an embodiment of the present invention.

FIG. 2 illustrates a front view of a water dispenser apparatus having doors and covers opened and showing internal compartments thereof in an embodiment of the present invention.

FIG. 3 illustrates a side cut-away view of a water dispenser apparatus in an embodiment of the present invention.

FIG. 4 illustrates a perspective view of a dispensing faucet in an embodiment of the present invention.

FIG. 5 illustrates an exploded view of a flow restrictor plug for a dispensing faucet in an embodiment of the present invention.

FIG. 6 illustrates an exploded view of a dispensing faucet vent for a dispensing faucet in an embodiment of the present invention.

FIG. 7 illustrates an overflow and dispense chamber and various components thereof in an embodiment of the present invention.

FIG. 8 illustrates a cross-sectional view along lines VIII-VIII of an overflow and dispense chamber and various components thereof in an embodiment of the present invention.

FIG. 9 illustrates a cross-sectional view along lines IX-IX of various components of an overflow dispense chamber in an embodiment of the present invention.

FIG. 10 illustrates a close-up perspective view of a hot beverage dispenser and a hot water, cold water, and sparkling water faucet of a water dispensing apparatus in an embodiment of the present invention.

### DETAILED DESCRIPTION OF THE PRESENTLY PREFERRED EMBODIMENTS

The present invention relates to water dispensing apparatus, systems, and methods of using the same. Specifically, the water dispensing apparatus comprises a tank for heating water, a separate chamber for dispensing the hot water, and a system for routing the hot water in a first hot water path to a hot water dispenser outlet in a first path or a hot water beverage dispenser outlet in a second hot water path. Systems and methods for dispensing hot water and hot beverages is further provided.

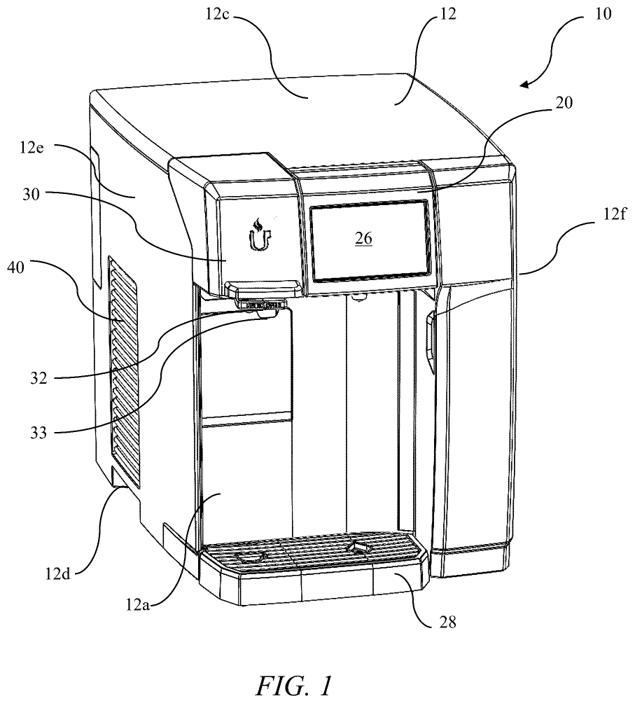

Now referring in greater details to the drawings, FIG. 1 illustrates a water dispenser apparatus 10 in an embodiment of the present invention. The water dispenser apparatus 10 includes a housing 12 having a front wall 12a, a rear wall 12b, a top wall 12c, a bottom wall 12d, a left side wall 12e and a right side wall 12f (when facing its front wall 12a). The front wall 12a further comprises various compartments for holding various elements therein, as described in more detail below, and further has several doors and covers for covering various components, as described in more detail below.

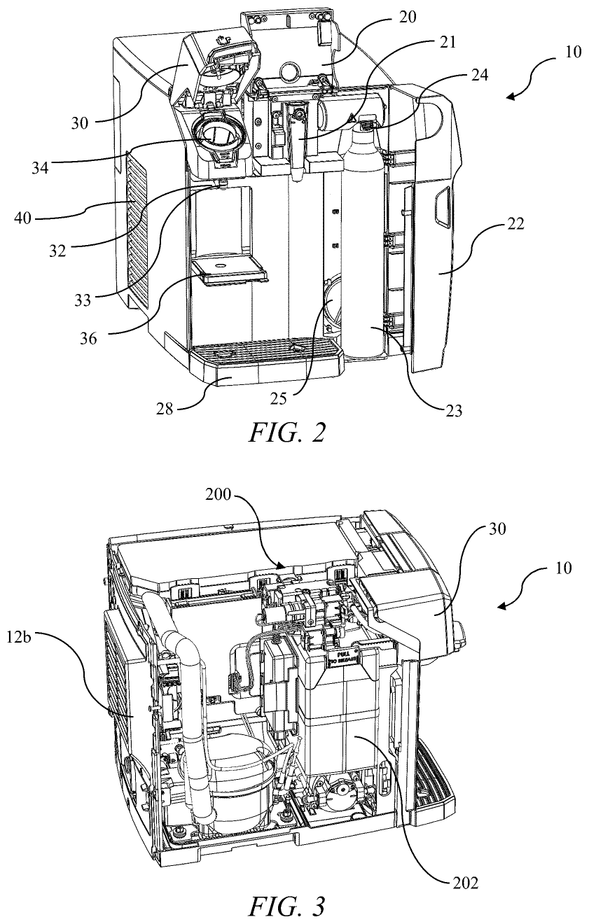

Referring to FIGS. 1 and 2, the front wall 12a may comprise a faucet cover 20 that may be hingedly attached to the front wall 12a or to the top wall 12c of the housing 12 to cover a faucet 21 (as illustrated in FIG. 2), described in more detail below. Further, the front wall 12a may comprise a carbon dioxide tank door 22 for covering a carbon dioxide tank 23 and a hinged bracket and valve 24 for holding the carbon dioxide tank 23 thereon. Moreover, the front wall 12a may comprise a filter door 25 for covering a water filter (not shown) and compartment therein for holding the water filter. In addition, the front wall 12a may comprise a touch-screen control panel 26 for controlling various aspects of the water dispenser 10.

A hot beverage dispenser cover 30 may further be hingedly attached to either the front wall 12a or the top wall 12c, wherein a hot beverage dispenser outlet 32 may be disposed therebeneath. A hot beverage pod receptacle 34 may be disposed within the cover 30, configured to hold a pod or cartridge containing an amount of coffee, tea, or other beverage material that may form a hot beverage when hot water is dispensed therethrough and combined therewith. Generally, the pods may be referred to as K-Cup® cartridges from Keurig Green Mountain, Inc., but may be referred to under other names and from other manufacturers.

A separate hot water dispenser outlet 33 may also be disposed beneath the hot beverage dispenser cover 30 for dispensing hot water that does not pass through the hot water beverage pod receptacle 34 providing clean hot water therethrough.

Further, a hinged platform 36 may extend from the front wall 12a to hold a cup, glass, or mug thereon, such as a coffee mug, for receiving the hot beverage generated through the hot beverage dispenser outlet 32 or hot water through the hot water dispenser outlet 33.

A glass or cup holder platform 28 may be snap-mounted to the front wall 12a, spaced below faucet cover 20 and on which a glass, cup or other beverage container may be positioned below the faucet 21. Moreover, the platform 28 may further extend beneath the hinged platform 36 so that a larger cup, glass, mug, or other hot beverage receptacle may be placed on the platform 28 instead of the hinged platform 36 wherein the hinged platform would be stowed, so as to allow larger glasses, cups, mugs, or other hot beverage or hot water receptacles to be placed thereon.

A vent 40 is illustrated in left side wall 12e, and it should be noted that various vents may be positioned on the housing 12 in various locations as needed to move air in or out of the housing, as necessary for cooling internal components thereof.

A processor may control the touch-screen control panel 26 and provide functionality to a user thereof, such as providing the user the ability to select several types of water dispensed therefrom, namely hot still water, cold still water, cold carbonated water, and ambient water, all of which may be filtered. Likewise, the processor may allow a user to select a hot beverage through the hot beverage dispenser outlet 32. Moreover, the processor may control various internal elements of the water dispenser 10, such as a cold water module, a hot water module, a water carbonation module, and various related components thereto, such as a compressor, a heater, a fan, valves, and other like elements, described in more detail below. Moreover, the processor may display error messages and instructions for clearing error messages, may further provide any other functionality or messaging apparent to one of ordinary skill in the art, and may be upgradable as needed.

The water dispenser apparatus 10 may provide water through the faucet 21 (such as, for example, ambient temperature water, cold water, and/or sparkling water), a hot beverage through the hot beverage dispenser outlet 32, and, alternatively, hot water through the hot water dispenser outlet 33, which may preferably be positioned adjacent (such as, for example, in front of) the hot water beverage dispenser outlet 32, as illustrated in FIG. 2. Specifically, various internal components may include the aforementioned water filter for filtering incoming water from a water source, a cold water module, a water carbonation module, and the hot water module. The various modules that may be contained within the water dispenser 10 may be the same or similar to the modules described in U.S. Pat. No. 10,399,839 to Knoll et al. and U.S. Pat. No. 10,526,187 to Knoll et al., each of which is incorporated herein by reference in its entirety.

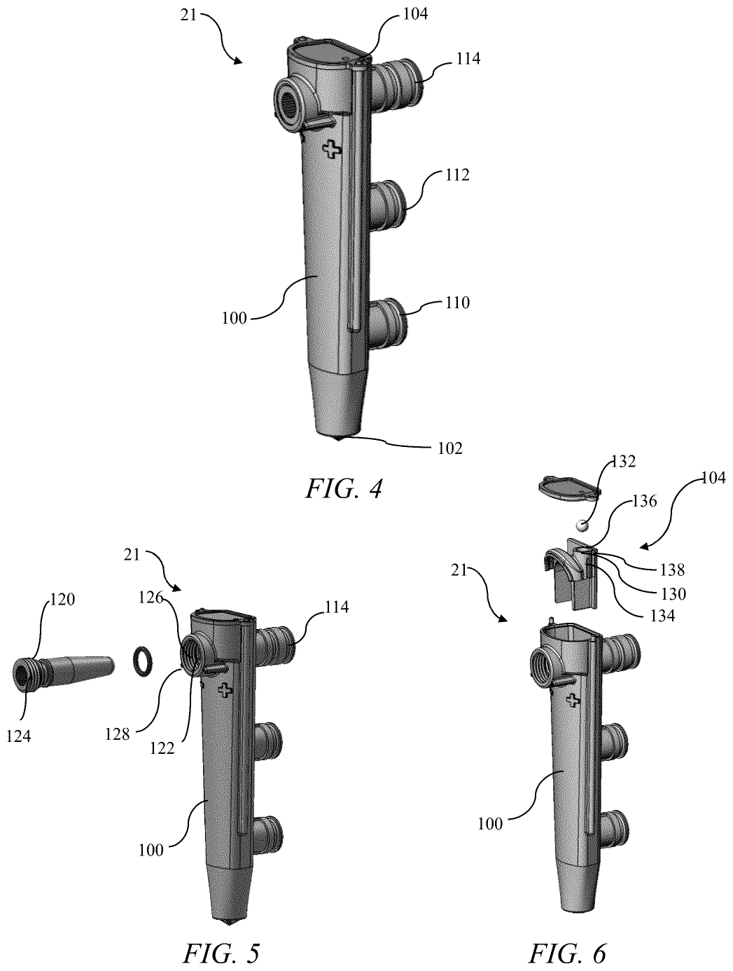

FIGS. 4-6 illustrate close-up perspective views of the faucet 21, which may be interconnected with the various water lines and the outlets thereof, namely a cold water line outlet (not shown), a sparkling water line outlet (not shown), and an ambient temperature water line outlet (not shown). Specifically, the faucet 21 may receive water from any of the aforementioned outlets and may funnel the water through a body 100 of the faucet 21 through a faucet mouth 102 on a bottom thereof via gravity. One or more vents 104 may be disposed on a top of the faucet 21, each having an air passage extending through the body 100 of the faucet 21 to ensure that the water flows therefrom without causing a vacuum therein, which may impede the flow of water therethrough.

The faucet 21 may have a plurality of bosses, namely, a cold water line boss 110, serving as a cold water dispenser, that interconnects with the cold water line outlet (not shown), an ambient water line boss 112, serving as an ambient water dispenser that interconnects with the ambient water line outlet (not shown), and a sparkling water line boss 114, serving as a sparkling water dispenser, that interconnects with the sparkling water line outlet (not shown). Each boss may have an O-ring (not shown) for sealing the same when fitted within each respective line outlet so that water does not leak from the point of interconnection.

FIG. 5 illustrates a close-up exploded view of the faucet 21 and a tapered plug 120 and that operates as a flow restrictor that may be disposed within the faucet 21 inside the sparkling water line boss 114. The tapered plug 120 may generally fit a mating surface 122 within the sparkling water line boss 114, and further may have a thread 124 that mates with thread 126 within a plug opening 128 that forms a passage from one side of the faucet 21 to the other and into the sparkling water line boss 114. The tapered plug 120 may be manually moved into and out of boss 114, thereby increasing or decreasing, respectively, the rate of sparkling water flow therethrough. Thus, the tapered plug may manually move closer or further away from mating surface 122. When the tapered plug moves closer to mating surface 122, the flow of sparkling water therethrough may be restricted due to the relatively smaller passageway provided between the tapered plug 120 and the mating surface 122. Likewise, when the tapered plug moves further away from the mating surface 122, the flow of sparkling water therethrough may be increased due to the relatively larger passageway provided between the tapered plug 120 and the mating surface 122.

It is preferably desirable to control the flow rate of the sparkling water dispensed from the faucet 21 to ensure proper mixing of carbon dioxide and water. A user may adjust the position of the tapered plug within the sparkling water boss 114 to induce back pressure on the sparkling water and prevent separation of carbon dioxide from the water. A driver, such as a hex tool, may be used to turn the tapered plug 120 within the sparkling water boss 114 thereby opening or closing the boss 114 and impacting the rate of the flow of water therethrough and the back pressure induced on the sparkling water stream. The position of the tapered plug may alternatively be adjusted via a grippable knob that may be grasped and rotated, thereby not requiring a tool for turning the same. Moreover, limits may be set on the tapered plug 120 to prevent over-turning, thereby preventing the tapered plug 120 from opening or closing too far.

FIG. 6 illustrates an exploded view of the dispensing faucet 21 and, more specifically, the vent 104. The vent may comprise a slotted port 130 which may contain a moveable, floatable check element 132, such as, for example, a floatable check ball made from, for example, polypropylene or another material that may float in water, that may be disposed within the slotted port 130. The slotted port 130 may allow air to enter the faucet 21 from the top of the faucet 21 and into the faucet 21 through a slot 134 within the slotted port 130. In such an event, the check element 132 may be disposed beneath the slot 134 thereby allowing air to flow through a top 136 of the slotted port 130, through the slot 134, and into the body 100 to aid in the dispensing of water through the faucet 21 without being inhibited by a vacuum created therein.

In the event that water, specifically pressurized sparkling water, for example, backs up within the faucet 21, the water may rise within the slotted port 130 and float the check element 132 to the top 136 of the slotted port 130 where it may then be held against a rim 138 thereon, effectively blocking water from exiting the faucet through the vent 104. As the water level decreases, the check element 132 may fall within the slotted port 130, thereby opening the slotted port 130 to air flow to allow the vent 104 to prevent vacuum formation within the faucet 21 during use thereof. By blocking the top 136 of the slotted port 130 when water backs up within the faucet 21, splattering, spilling, or spraying of the water through the vent 104 may be prevented.

Now referring back to FIG. 3, which illustrates a hot water or beverage dispensing module 200, in an embodiment of the present invention, the hot water or beverage dispensing module 200 may generally comprise a hot water tank 202 that may feed hot water to a dispense chamber 230, which may then alternately feed hot water to the hot water dispenser outlet 33 or to the hot beverage dispenser outlet 32 described in more detail below.

Thus, the apparatus 10 of the present invention comprises alternative paths for dispensing hot water therefrom. In a first hot water path, hot water may be dispensed from the hot water tank 202 through the dispense chamber 230 to the hot water dispenser outlet 33 when a user simply wants hot water dispensed therefrom and not a hot beverage of combined hot water and coffee, tea, or other like hot beverage. In a second hot water path, the hot water may be routed and precisely metered to dispense an amount of hot water from the dispense chamber 230 through the hot beverage dispenser outlet 32 via the hot beverage pod receptacle 34 containing a pod of a beverage material through which the hot water may percolate and form a hot beverage.

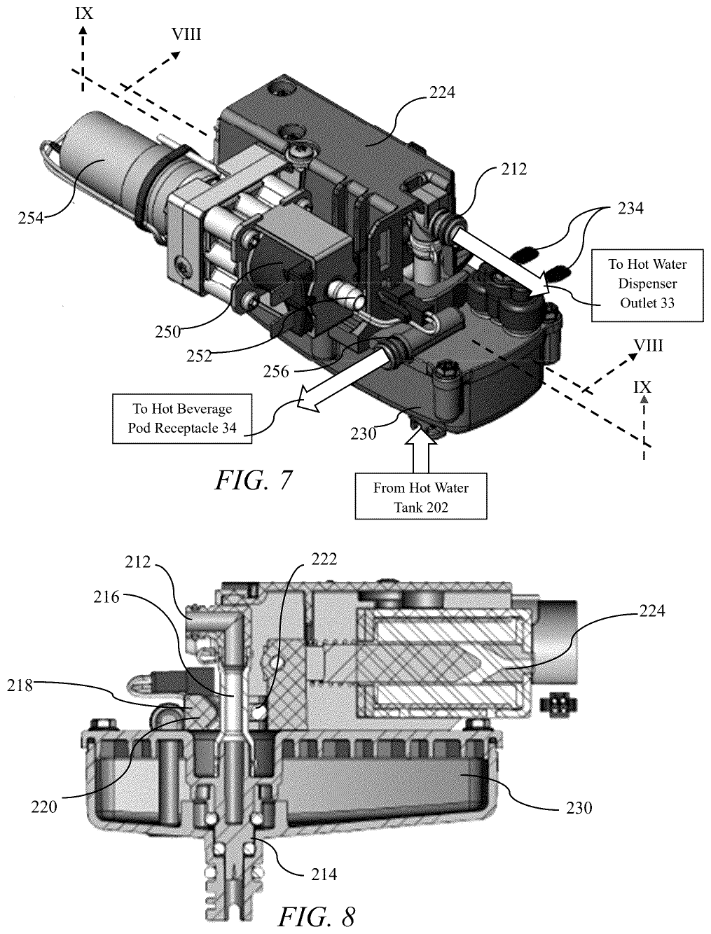

Now referring to FIGS. 7-9, the hot water or beverage dispensing module 200 is illustrated in more detail, which alternately routes hot water through the first or the second hot water paths, as desired by a user. The hot water or beverage dispensing module 200 may comprise the hot water tank 202, as illustrated in FIG. 3, and the dispense chamber 230, which may sit atop the hot water tank 202. Water may be heated within the hot water tank 202 and may be pushed through a stem 214 via Venturi forces into the dispense chamber 230. The hot water may, thereafter, be distributed from the dispense chamber 230 via the first path to the hot water dispenser outlet 33 or via the second path to the hot beverage dispenser outlet 32.

In the first hot water path, the hot water may be drawn from the dispense chamber 230 through a hot water outlet tube 216, through a hot water boss 212, and, as illustrated in FIG. 7, to a tube that may route the hot water directly to the hot water dispenser outlet 33 (such as, for example, without passing through the hot beverage pod receptacle 34 for mixing with beverage ingredients). To allow water to flow from the dispense chamber 230 through the hot water outlet tube 216 and through the hot water dispenser outlet 33, a vent 252 that may be in communication with dispense chamber 230 via an air passage (not shown), may be opened via a three-way valve driven by motor 250. The vent 252 may thus allow airflow into the dispense chamber 230 when opened by the three-way valve via the motor 250. A user may then collect the hot water beneath the hot water dispenser outlet 33.

Alternatively in the second hot water path, namely in a hot beverage dispenser cycle, if desired by the user, hot water may be routed from the dispense chamber 230 to the hot beverage pod receptacle 34 via a hot beverage boss 256, which may flow through a tube (not shown) to the hot beverage pod receptacle 34 for admixing with beverage ingredients, such as coffee, tea, or other like ingredients and then, ultimately, to the hot beverage dispenser outlet 32.

To facilitate the movement of the hot water in the second hot water path, the first hot water path (through the hot water outlet tube 216 and hot water boss 212) is closed., To accomplish the closing of the first hot water path, the hot water outlet tube 216, which may be made of a flexible elastomeric material, may be pinched closed using a clamp 218 having a pinching element 220, and retracting the pinching element 220 via a solenoid 224 toward a bar 222 which may effectively pinch off the hot water outlet tube 216 thereby preventing the flow of hot water therethrough from the dispense chamber 230. When the solenoid 224 deenergizes, the pinching element 220 may return to its original position, thereby opening hot water outlet tube 216 to again allow the flow of hot water therethrough.

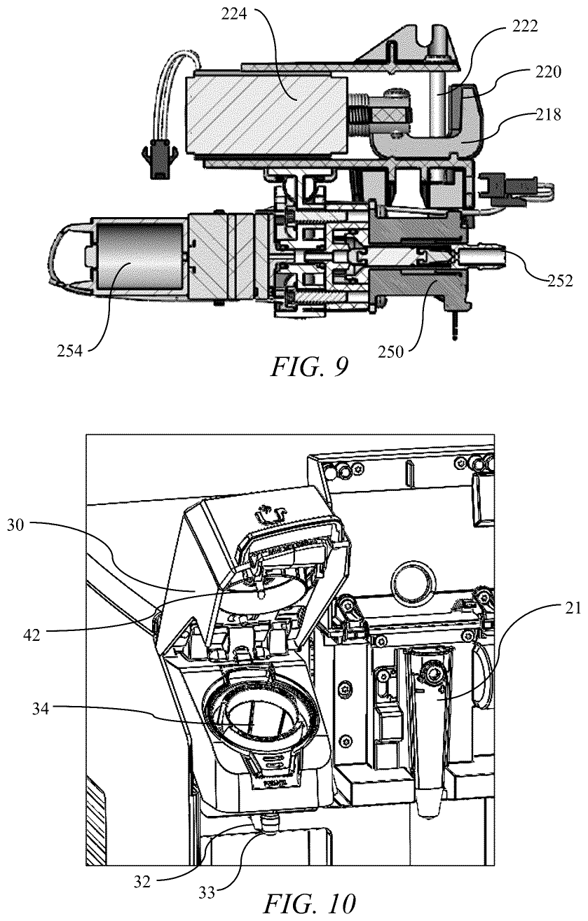

FIG. 8 illustrates a cross-sectional view along lines VIII-VIII in FIG. 7 of the dispense chamber 230 that may sit atop the hot water tank 202. FIG. 9 illustrates a cross-sectional view along lines IX-IX in FIG. 7 of various components that may allow hot water to be pulled from the dispense chamber 230 to the hot beverage dispenser outlet 32 through the hot beverage pod receptacle 34 for brewing a brewed beverage, such as coffee, tea, or other brewed beverage, instead of through the hot water boss 212 and through the hot water dispenser outlet 33.

In a hot beverage cycle, the dispense chamber 230 may be filled with an amount of hot water. An air pump 254 may pump air into the dispense chamber through the air passage displacing the hot water contained therein through the hot beverage boss 256 so that hot water dispensed therethrough the beverage pod receptacle 34 may be precisely controlled and metered. Specifically, it may be desired that a specific amount, such as 2 ounces, of hot water may be cycled into the hot beverage pod receptacle 34 A plurality of cycles may be utilized to dispense the desired amount of hot water, such as any amount in multiples of 2 ounces, for example, or any other metered amount within the dispense and overflow chamber 230. Level sensor probes 234 within the dispense and overflow chamber 230 may be used to detect the level of hot water within the dispense chamber 230 for dispensing the specified metered amount of hot water, for example.

During the hot beverage cycle, as disclosed above, the solenoid 224 may retract the clamp 218 to seal hot water outlet tube 216, specifically by clamping or pinching the hot water outlet tube 216 thereby closing flow of hot water therethrough. Thus, instead of dispensing hot water through the hot water dispenser outlet 33, a metered amount of hot water may be pumped from the dispense chamber 230. At or nearly at the same time, the three-way valve may be controlled via motor 250 thereby closing vent 252 and blocking the airflow through the vent 252 into the dispense chamber 230. The air pump 254 may energize to force the desired amount of water within the dispense chamber 230 through the hot beverage boss 256, which may feed the hot water dispensed from the dispense chamber 230 into the hot beverage pod receptacle 34 containing a disposable or reusable pod of coffee, tea, or other brewable substance for brewing thereof and dispensing therefrom.

In a preferred embodiment, the hot beverage pod receptacle 34 may fit a typical single-serve brew pod or cartridge containing matter to be brewed and a filter, such as, for example, so-called K-cups® and/or other similar pods or cartridges. In operation, the pod may be placed within the receptacle 34 and the hinged hot beverage dispenser cover 30 may be closed, thereby causing the hot beverage dispenser 40, which may be a hollow spike or needle, to pierce the pod allowing hot water to flow therethrough and into the pod for filing the same with water. A similar spike or needle may further pierce the pod from the bottom thereof, allowing the water to flow therethrough brewing the hot beverage.

Therefore, hot water from the hot water tank 202 may be routed either through the first path to the hot water dispenser outlet 33 or through the second path to the hot beverage dispenser outlet 32.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A water dispensing apparatus comprising:
a hot water tank; and
a dispense chamber disposed above the hot water tank comprising an inlet for moving hot water from the hot water tank to the dispense chamber, a first outlet for moving hot water via a first path from the dispense chamber to a hot water dispenser outlet, and a second outlet for moving hot water via a second path from the dispense chamber to a beverage ingredient chamber containing an amount of a beverage ingredient for forming a hot beverage when combined with the hot water,
wherein the hot water flows alternately through the first water path to the first dispenser and through the second water path to the second dispenser.

2. The water dispensing apparatus of claim 1 wherein the beverage ingredient chamber is a brew chamber configured to hold the beverage ingredient.

3. The water dispensing apparatus of claim 2 wherein the brew chamber is configured to dispense a brewed beverage therefrom when hot water flows through the second water path and the beverage ingredient is held within the brew chamber.

4. The water dispensing apparatus of claim 1 further comprising:
a clamp configured to close the first water path when the hot water is configured to flow through the second water path.

5. The water dispensing apparatus of claim 4 further comprising:
a valve associated with the dispense chamber wherein the valve is configured to close one or more vents in the hot water tank when the hot water is configured to flow through the second water path.

6. The water dispensing apparatus of claim 5 further comprising:
a pump associated with the dispense chamber wherein the pump is configured to move water within the dispense chamber through the second water path.

7. The water dispensing apparatus of claim 6 wherein the pump is configured to move a predefined amount of water through the second water path.

8. The water dispensing apparatus of claim 7 wherein the hot water within the dispense chamber is measured using one or more sensor probes.

9. The water dispensing apparatus of claim 1 further comprising:
at least one sensor probe for measuring the amount of hot water within the dispense chamber.

10. The water dispensing apparatus of claim 1 wherein the hot water tank and the dispense chamber comprise a water flow pathway that is configured to allow water to flow from the hot water tank to the dispense chamber.

11. A method of dispensing hot water from a dispensing apparatus comprising the steps of:
providing a hot water tank for forming hot water;
providing a dispense chamber disposed above the hot water tank comprising a hot water inlet for moving the hot water from the hot water tank to the dispense chamber, a first outlet for moving the hot water in a first water path from the dispense chamber to a hot water dispenser outlet, and a second outlet for moving the hot water in a second water path from the dispense chamber to a beverage ingredient chamber containing an amount of a beverage ingredient for forming a hot beverage when combined with the hot water and further wherein the second path comprises a hot beverage dispenser outlet for dispensing the hot beverage after combining the hot water with the beverage ingredient; and
moving the hot water alternately through the first water path or through the second water path.

12. The method of claim 11 wherein the beverage ingredient chamber is configured to hold a brew-able material, further comprising the steps of:
filling the beverage ingredient chamber with the brew-able material;
moving the hot water through the second water path to the beverage ingredient chamber and brewing the brew-able material within the beverage ingredient chamber to form a brewed beverage; and
dispensing the brewed beverage through the hot beverage dispenser outlet.

13. The method of claim 12 further comprising the step of:
dispensing the brewed beverage from the brewed beverage dispenser.

14. The method of claim 11 further comprising the steps of:
providing a clamp configured to close the first water path; and
clamping the first water path closed when moving the hot water through the second water path.

15. The method of claim 14 further comprising the steps of:
providing a valve associated with the dispense chamber configured to close one or more vents in the hot water tank; and
closing the one or more vents in the hot water tank via the valve.

16. The method of claim 15 further comprising the steps of:
providing a pump associated with the dispense chamber wherein the pump is configured to move water within the dispense chamber through the second water path; and
moving the hot water from the dispense chamber through the second water path.

17. The method of claim 16 further comprising the steps of:
measuring a first amount of hot water within the dispense chamber; and
moving the first amount of hot water through the second water path with the pump.

18. The method of claim 17 wherein the amount of water within the dispense chamber is measured using one or more sensor probes.

19. The method of claim 17 further comprising the steps of:
filling the dispense chamber with a second amount of hot water; and
moving the second amount of hot water through the second water path with the pump.

20. The method of claim 11 wherein the hot water tank and the dispense chamber comprise a water flow pathway that is configured to allow water to flow from the hot water tank to the dispense chamber.
